(19) United States
(12) Patent Application Publication
(10) Pub. No.: US 2018/0181224 A1
(43) Pub. Date: Jun. 28, 2018

(54) FLEXIBLE TOUCHSCREEN AND FLEXIBLE TOUCH DISPLAY

(71) Applicant: Wuhan China Star Optoelectronics Technology Co., Ltd., Wuhan, Hubei (CN)

(72) Inventors: Bo LI, Wuhan, Hubei (CN); Yun YU, Wuhan, Hubei (CN); Jenyu LEE, Wuhan, Hubei (CN); Dinguo CHEN, Wuhan, Hubei (CN); Yong ZHAO, Wuhan, Hubei (CN)

(73) Assignee: Wuhan China Star Optoelectronics Technology Co., Ltd., Wuhan, Hubei (CN)

(21) Appl. No.: 15/324,148

(22) PCT Filed: Dec. 23, 2016
(86) PCT No.: PCT/CN2016/111627

§ 371 Date: Jan. 5, 2017

(30) Foreign Application Priority Data
Nov. 8, 2016 (CN) 201610979748.X

(51) Int. Cl. G06F 3/041

(52) U.S. Cl. CPC G06F 3/041; G06F 2203/04102

(57) ABSTRACT

A flexible touchscreen is provided. The flexible touchscreen has a flexible substrate, each surface of which is defined as two window areas and a bending area. Driving electrodes and sensing electrodes are manufactured in the two window areas; electrode lead lines are disposed outside of the two window areas; and there are no electrode disposed in the bending area, and no electrode lead lines passing therethrough. In the flexible touchscreen, the electrodes and the electrode lead lines are arranged outside of the bending area, so that the bending of the electrode lead lines can be avoided, so as to lengthen the lifetime of the flexible touchscreen.

### FIELD OF THE INVENTION

The present invention relates to a technical field of displays, and more particularly to a flexible touchscreen and a flexible touch display with the flexible touchscreen.

### BACKGROUND OF THE INVENTION

In the technical field of displays, a touchscreen (touch panel) as a new input device is widely applied in the technical field of touch displays. The touchscreens include resistive, capacitive, optical, electromagnetic touchscreens, etc. The capacitive touchscreen has the advantages of quick response, good reliability, high durability, multi-touch, etc., and is more applied in mobile terminals. At the same time, with the technological development of flexible displays, the current mobile terminals, such as mobile phones, smartwatches, and smart bracelets, have a development direction of slim and flexible (bendable). Thus, the touchscreen used in a mobile terminal is required to be flexible, namely thin and bendable.

Currently, the most used flexible touchscreen is an external hanging capacitive touchscreen, wherein a flexible plastic is used to be a base material thereof; electrode circuits of transparent conducting films are manufactured thereon; and then the touchscreen is attached to a flexible display by an adhering process. The most used material of the transparent conducting film is an indium tin oxide (ITO), and the manufacturing technology thereof is mature, but the brittleness thereof is higher. When a flexible display equipment is bent in usage, ITO transparent sensing electrodes easily produce an accumulation of stress, and gashes occur and expand thereon, which cause poor touch performance.

As mentioned above, the bending endurance of the conventional flexible touchscreen is worse, so that the electrode circuits in the bended portion are frequently broken by the accumulation of stress, so as to influence the quality of the products. Hence, it is necessary to provide a flexible touchscreen with a better bending endurance.

### SUMMARY OF THE INVENTION

The present invention provides a flexible touchscreen structure which changes an arranging structure of electrode lead lines, so as to prevent the electrode lead lines from damage caused by repeat bending, to solve a technical problem: in a conventional flexible touchscreen, the electrode lead lines thereof in a bended portion are easily damaged by an accumulation of stress, so as to influence the touch effect of the flexible touchscreen.

For solving the above-mentioned problem, the present invention provides a flexible touchscreen, which comprises:
a flexible substrate, each surface of which is defined as a bending area and two window areas, wherein a plurality of electrode layers are manufactured on the surfaces of the flexible substrate; a midline area of each of the electrode layers is empty; the midline area is formed as the bending area; the electrode layers beside the midline area are formed as the two window areas; and the two window areas are symmetrically disposed according to an axis formed by a midline of the bending area;
a first circuit board bonding unit disposed on one side of the bending area;
a second circuit board bonding unit disposed on the other side of the bending area;
a first electrode lead line group disposed on the same side of the first circuit board bonding unit as the bending area, wherein the first electrode lead line group is configured to connect the electrode layer of the same side and the first circuit board bonding unit; and
a second electrode lead line group disposed on the same side of the second circuit board bonding unit as the bending area, wherein the second electrode lead line group is configured to connect the electrode layer of the same side and the second circuit board bonding unit.

According to one preferred embodiment of the present invention, the electrode layers include driving electrodes and sensing electrodes insulated from each other; the driving electrodes are manufactured on one surface of the flexible substrate; and the sensing electrodes are manufactured on the other surface of the flexible substrate.

According to one preferred embodiment of the present invention, the first circuit board bonding unit includes a first sub-circuit board bonding portion and a second sub-circuit board bonding portion; and the second circuit board bonding unit includes a third sub-circuit board bonding portion and a fourth sub-circuit board bonding portion; and
the first electrode lead line group includes a first sub-electrode lead line and a second sub-electrode lead line; and the second electrode lead line group includes a third sub-electrode lead line and a fourth sub-electrode lead line; wherein the first sub-electrode lead line is configured to connect between the sensing electrodes and the second sub-circuit board bonding portion; the second sub-electrode lead line is configured to connect between the driving electrodes and the first sub-circuit board bonding portion; the third sub-electrode lead line is configured to connect between the sensing electrodes and the fourth sub-circuit board bonding portion; and the fourth sub-electrode lead line is configured to connect between the driving electrodes and the third sub-circuit board bonding portion.

According to one preferred embodiment of the present invention, the first sub-electrode lead line, the third sub-electrode lead line, the second sub-circuit board bonding portion, the fourth sub-circuit board bonding portion, and the sensing electrodes are positioned on the same surface of the flexible substrate; and the second sub-electrode lead line, the fourth sub-electrode lead line, the first sub-circuit board bonding portion, the third sub-circuit board bonding portion, and the driving electrodes are positioned on the other surface of the flexible substrate.

According to one preferred embodiment of the present invention, the first sub-circuit board bonding portion, the second sub-circuit board bonding portion, the third sub-circuit board bonding portion, and the fourth sub-circuit board bonding portion are positioned on the same surface of the flexible substrate; and the surfaces of the flexible substrate are provided with a plurality of through holes, and electrical connecting points are filled in the through holes, so that the electrode lead line on the other surface of the flexible substrate can be connected to the corresponding circuit board bonding portion through the electrical connecting points.

The present invention further provides a flexible touchscreen, which comprises:
a flexible substrate, each surface of which is defined as a bending area and two window areas, wherein a plurality of electrode layers are manufactured on the surfaces of the flexible substrate; a midline area of each of the electrode layers is empty; the midline area is formed as the bending area; and the electrode layers beside the midline area are formed as the two window areas;
a first circuit board bonding unit disposed on one side of the bending area;
a second circuit board bonding unit disposed on the other side of the bending area;
a first electrode lead line group disposed on the same side of the first circuit board bonding unit as the bending area, wherein the first electrode lead line group is configured to connect the electrode layer of the same side and the first circuit board bonding unit; and
a second electrode lead line group disposed on the same side of the second circuit board bonding unit as the bending area, wherein the second electrode lead line group is configured to connect the electrode layer of the same side and the second circuit board bonding unit.

According to one preferred embodiment of the present invention, the electrode layers include driving electrodes and sensing electrodes insulated from each other; the driving electrodes are manufactured on one surface of the flexible substrate; and the sensing electrodes are manufactured on the other surface of the flexible substrate.

According to one preferred embodiment of the present invention, the first circuit board bonding unit includes a first sub-circuit board bonding portion and a second sub-circuit board bonding portion; and the second circuit board bonding unit includes a third sub-circuit board bonding portion and a fourth sub-circuit board bonding portion; and
the first electrode lead line group includes a first sub-electrode lead line and a second sub-electrode lead line; and the second electrode lead line group includes a third sub-electrode lead line and a fourth sub-electrode lead line; wherein the first sub-electrode lead line is configured to connect between the sensing electrodes and the second sub-circuit board bonding portion; the second sub-electrode lead line is configured to connect between the driving electrodes and the first sub-circuit board bonding portion; the third sub-electrode lead line is configured to connect between the sensing electrodes and the fourth sub-circuit board bonding portion; and the fourth sub-electrode lead line is configured to connect between the driving electrodes and the third sub-circuit board bonding portion.

According to one preferred embodiment of the present invention, the first sub-electrode lead line, the third sub-electrode lead line, the second sub-circuit board bonding portion, the fourth sub-circuit board bonding portion, and the sensing electrodes are positioned on the same surface of the flexible substrate; and the second sub-electrode lead line, the fourth sub-electrode lead line, the first sub-circuit board bonding portion, the third sub-circuit board bonding portion, and the driving electrodes are positioned on the other surface of the flexible substrate.

According to one preferred embodiment of the present invention, the first sub-circuit board bonding portion, the second sub-circuit board bonding portion, the third sub-circuit board bonding portion, and the fourth sub-circuit board bonding portion are positioned on the same surface of the flexible substrate; and the surfaces of the flexible substrate are provided with a plurality of through holes, and electrical connecting points are filled in the through holes, so that the electrode lead line on the other surface of the flexible substrate can be connected to the corresponding circuit board bonding portion through the electrical connecting points.

According to the above-mentioned purpose of the present invention, a flexible touch display is provided, which comprises:
a flexible display; and
a flexible touchscreen positioned on an upper surface of the flexible display and electrically connected with the flexible display;
wherein the flexible touchscreen comprises:
a flexible substrate, each surface of which is defined as a bending area and two window areas, wherein a plurality of electrode layers are manufactured on the surfaces of the flexible substrate; a midline area of each of the electrode layers is empty; the midline area is formed as the bending area; the electrode layers beside the midline area are formed as the two window areas; and the two window areas are symmetrically disposed according to an axis formed by a midline of the bending area;
a first circuit board bonding unit disposed on one side of the bending area;
a second circuit board bonding unit disposed on the other side of the bending area;
a first electrode lead line group disposed on the same side of the first circuit board bonding unit as the bending area, wherein the first electrode lead line group is configured to connect the electrode layer of the same side and the first circuit board bonding unit; and
a second electrode lead line group disposed on the same side of the second circuit board bonding unit as the bending area, wherein the second electrode lead line group is configured to connect the electrode layer of the same side and the second circuit board bonding unit.

According to one preferred embodiment of the present invention, the electrode layers include driving electrodes and sensing electrodes insulated from each other; the driving electrodes are manufactured on one surface of the flexible substrate; and the sensing electrodes are manufactured on the other surface of the flexible substrate.

According to one preferred embodiment of the present invention, the first circuit board bonding unit includes a first sub-circuit board bonding portion and a second sub-circuit board bonding portion; and the second circuit board bonding unit includes a third sub-circuit board bonding portion and a fourth sub-circuit board bonding portion; and
the first electrode lead line group includes a first sub-electrode lead line and a second sub-electrode lead line; and the second electrode lead line group includes a third sub-electrode lead line and a fourth sub-electrode lead line; wherein the first sub-electrode lead line is configured to connect between the sensing electrodes and the second sub-circuit board bonding portion; the second sub-electrode lead line is configured to connect between the driving electrodes and the first sub-circuit board bonding portion; the third sub-electrode lead line is configured to connect between the sensing electrodes and the fourth sub-circuit board bonding portion; and the fourth sub-electrode lead line is configured to connect between the driving electrodes and the third sub-circuit board bonding portion.

According to one preferred embodiment of the present invention, the first sub-electrode lead line, the third sub-electrode lead line, the second sub-circuit board bonding portion, the fourth sub-circuit board bonding portion, and the sensing electrodes are positioned on the same surface of the flexible substrate; and the second sub-electrode lead line, the fourth sub-electrode lead line, the first sub-circuit board bonding portion, the third sub-circuit board bonding portion, and the driving electrodes are positioned on the other surface of the flexible substrate.

According to one preferred embodiment of the present invention, the first sub-circuit board bonding portion, the second sub-circuit board bonding portion, the third sub-circuit board bonding portion, and the fourth sub-circuit board bonding portion are positioned on the same surface of the flexible substrate; and the surfaces of the flexible substrate are provided with a plurality of through holes, and electrical connecting points are filled in the through holes, so that the electrode lead line on the other surface of the flexible substrate can be connected to the corresponding circuit board bonding portion through the electrical connecting points.

The advantageous effects of the present invention are: compared to a conventional flexible touchscreen, in the flexible touchscreen of the present invention, because electrodes and electrode lead lines are arranged to avoid a bending area of the touchscreen, the electrodes are prevented from being bent, so as to decrease damage of the electrode lead lines caused by bending stress of the touchscreen, so that the service life of the flexible touchscreen is increased. The present invention can solve a technical problem: in a conventional flexible touchscreen, the electrode circuits thereof in a bended portion are easily worn or broken by an accumulation of stress, so as to influence the touch effect of the flexible touchscreen.

### DESCRIPTION OF THE DRAWINGS

The above-mentioned contents of the present invention can be best understood by referring to the following detailed description of the preferred embodiments and the accompanying drawings.

FIG. 1 is a schematic structural view of a flexible touchscreen according to a first preferred embodiment of the present invention.

FIG. 2 is a schematic structural view of a flexible touchscreen according to a second preferred embodiment of the present invention.

### DETAILED DESCRIPTION OF THE PREFERRED EMBODIMENTS

The foregoing objects, features, and advantages adopted by the present invention can be best understood by referring to the following detailed description of the preferred embodiments and the accompanying drawings. Furthermore, the directional terms described in the present invention, such as upper, lower, front, rear, left, right, inside, outer, side, etc., are only directions with reference to the accompanying drawings, so that the used directional terms are used to describe and understand the present invention, but the present invention is not limited thereto. In the drawings, units with similar structures use the same numerals.

The present invention is configured to solve a technical problem: in a conventional flexible touchscreen, the electrode circuits thereof in a bended portion are easily worn or broken by an accumulation of stress, so as to influence the touch effect of the flexible touchscreen. This defect can be solved by the embodiments of the present invention.

A flexible touchscreen of the present invention comprises a flexible substrate, wherein a surface of the flexible substrate is defined as a first window area, a second window area, and a bending area, all of which correspond to a display area of a display; an electrode layer are manufactured on the surface of the flexible substrate; and a midline area of each of the electrode layers is empty. The midline area is formed as the bending area. The electrode layers beside the midline area are formed as the first window area and the second window area, wherein outside of the first window area and the second window area is a periphery area. Simultaneously, the bending area is positioned on a midline of the flexible substrate, the first window area and the second window area are symmetrically disposed according to an axis formed by a midline of the bending area. The flexible touchscreen can be bent according to the axis formed by the midline of the bending area. When the flexible touchscreen is bent, a proximity area of the midline of the flexible substrate bears a larger bending stress, and this area is defined as the bending area.

Both in the first window area and the second window area, there are driving electrodes and sensing electrodes arranged, wherein the driving electrodes are horizontally arranged; the sensing electrodes are vertically arranged; and the driving electrodes and the sensing electrodes are insulated from each other.

The driving electrodes and sensing electrodes are connected with electrode lead lines, respectively. The electrode lead lines are arranged in the periphery area, and the other ends of the electrode lead lines are connected to a circuit board bonding area, so as to connect to a control chip.

There are no electrodes disposed in the bending area, and no electrode lead lines passing therethrough.

For example, the left electrodes are disposed in the first window area, and the left circuit board bonding area and the left electrode lead lines are disposed in the outside of the first window area, wherein the left electrodes are connected to the left circuit board bonding area through the left electrode lead lines.

In the same way, the right electrodes are disposed in the second window area, and the right circuit board bonding area and the right electrode lead lines are disposed outside of the second window area, wherein the right electrodes are connected to the right circuit board bonding area through the right electrode lead lines.

The driving electrodes are manufactured on one surface of the flexible substrate, and the sensing electrodes are manufactured on the one surface of the flexible substrate. The two surfaces of the flexible substrate both correspondingly dispose the electrode lead lines, wherein one end of a electrode lead line is connected to the corresponding electrode, and the other end is connected to the corresponding circuit board bonding area.

The technical solution of the present invention can be accomplished by the embodiments below, which are specifically described as follows.

### First Embodiment

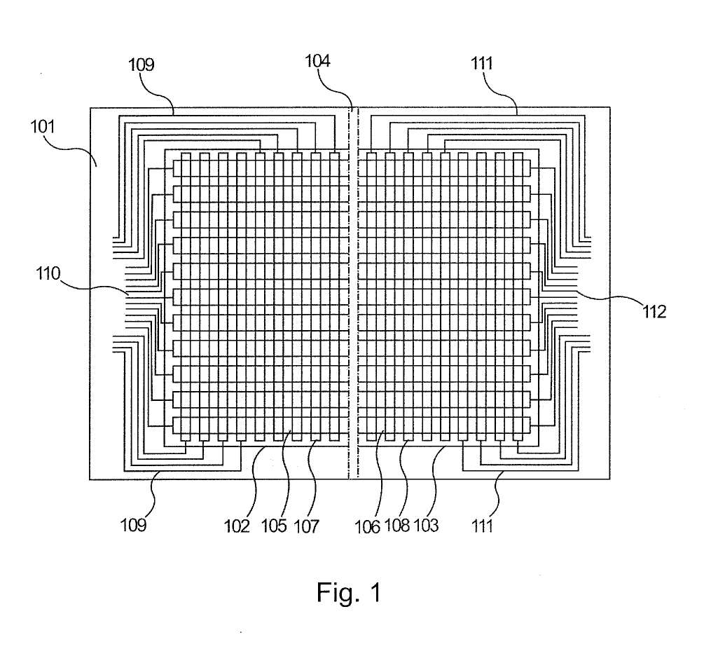

As shown in FIG. 1, a flexible touchscreen of the present invention comprises a flexible substrate 101, wherein each one of the surfaces thereof is defined as a first window area 102, a second window area 103, and a bending area 104 between the first window area 102 and the second window area 103. A plurality of electrodes are manufactured in the first window area 102 and the second window area 103, respectively. When in the manufacturing process, firstly, two surfaces of the flexible substrate 101 are deposited an indium tin oxide (ITO) conducting film by a magnetron sputtering technology, respectively, and next, a plurality of electrode layers and electrode lead lines are manufactured on the ITO conducting films on the two surfaces of the flexible substrate 101 by chemical etching. At the same time, the electrodes in a midline area of the flexible substrate 101 are removed. That is, a driving electrode layer and the corresponding electrode lead lines are disposed on one surface of the flexible substrate 101, and a sensing electrode layer and the corresponding electrode lead lines are disposed on the other surface of the flexible substrate 101.

For example, the surfaces of the flexible substrate 101 dispose a first driving electrode 105, a second driving electrode 106, a first sensing electrode 107, and a second sensing electrode 108, wherein the first driving electrode 105 and the second driving electrode 106 are positioned on the same surface of the flexible substrate 101, and the first driving electrode 105 and the second driving electrode 106 are positioned in two corresponding side of the bending area 104, respectively. In the same way, the first sensing electrode 107 and the second sensing electrode 108 are positioned on the other surface of the flexible substrate 101, and the first sensing electrode 107 and the second sensing electrode 108 are positioned in two corresponding side of the bending area 104, respectively.

A first circuit board bonding unit is disposed outside of the first window area 102, and a second circuit board bonding unit is disposed outside of the second window area 103. The first circuit board bonding unit includes a first sub-circuit board bonding portion and a second sub-circuit board bonding portion; and the second circuit board bonding unit includes a third sub-circuit board bonding portion and a fourth sub-circuit board bonding portion. The first sub-circuit board bonding portion, the third sub-circuit board bonding portion, the first driving electrode 105, and the second driving electrode 106 are positioned on the same surface of the flexible substrate 101; and the second sub-circuit board bonding portion, the fourth sub-circuit board bonding portion, the first sensing electrode 107, and the second sensing electrode 108 are positioned on the other surface of the flexible substrate 101.

A first electrode lead line group is disposed outside of the first window area 102, and a second electrode lead line group is disposed outside of the second window area 103. The first electrode lead line group includes a first sub-electrode lead line 109 and a second sub-electrode lead line 110; and the second electrode lead line group includes a third sub-electrode lead line 111 and a fourth sub-electrode lead line 112. The first sub-electrode lead line 109, the third sub-electrode lead line 111, the first sensing electrode 107, and the second sensing electrode 108 are positioned on the same surface of the flexible substrate 101; and the second sub-electrode lead line 110, the fourth sub-electrode lead line 112, the first driving electrode 105, and the second driving electrode 106 are positioned on the other surface of the flexible substrate 101.

The first sub-electrode lead line 109 is configured to connect between the first sensing electrode 107 and the second sub-circuit board bonding portion; the second sub-electrode lead line 110 is configured to connect between the first driving electrode 105 and the first sub-circuit board bonding portion; the third sub-electrode lead line 111 is configured to connect between the second sensing electrode 108 and the fourth sub-circuit board bonding portion; and the fourth sub-electrode lead line 112 is configured to connect between the second driving electrode 106 and the third sub-circuit board bonding portion.

In the structure of the flexible touchscreen of the embodiment, because the driving electrodes, the driving electrodes, and the electrode lead lines are disposed to avoid the bending area 104, the electrodes and the electrode lead lines are prevented from being damaged when the bending area 104 is bent to produce an accumulation of stress to influence the touch effect of whole of the touchscreen.

### Second Embodiment

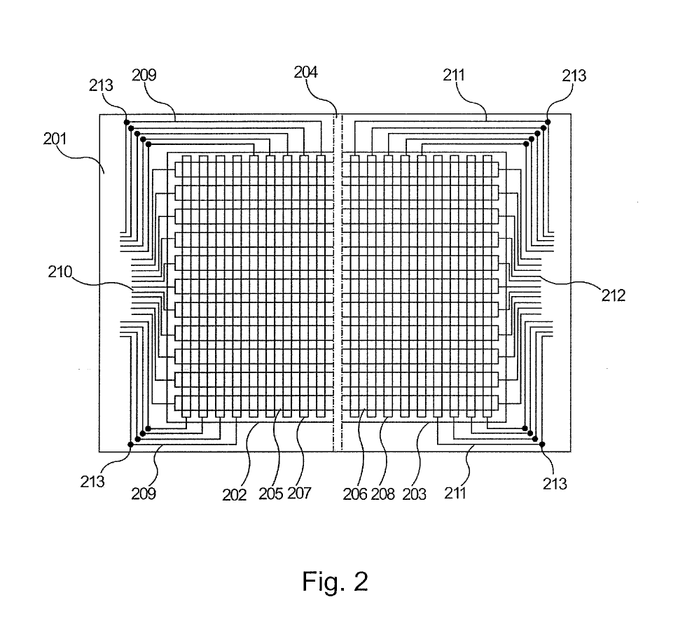

As shown in FIG. 2, a flexible touchscreen of the present invention comprises a flexible substrate 201, wherein a surface thereof is defined as a first window area 202, a second window area 203, and a bending area 204 between the first window area 202 and the second window area 203. A driving electrodes layer and a sensing electrode layer are manufactured in the first window area 202 and the second window area 203. The driving electrode layer is disposed on one surface of the flexible substrate 201, and the sensing electrode layer is disposed on the other surface of the flexible substrate 201.

The surfaces of the flexible substrate 201 dispose a first driving electrode 205, a second driving electrode 206, a first sensing electrode 207, and a second sensing electrode 208.

A first electrode lead line group is disposed outside of the first window area 202, and a second electrode lead line group is disposed outside of the second window area 203. The first electrode lead line group includes a first sub-electrode lead line 209 and a second sub-electrode lead line 210; and the second electrode lead line group includes a third sub-electrode lead line 211 and a fourth sub-electrode lead line 212.

A first circuit board bonding unit is disposed outside of the first window area 202, and a second circuit board bonding unit is disposed outside of the second window area 203. The first circuit board bonding unit includes a first sub-circuit board bonding portion and a second sub-circuit board bonding portion; and the second circuit board bonding unit includes a third sub-circuit board bonding portion and a fourth sub-circuit board bonding portion.

The difference between this embodiment and the first embodiment is: the first sub-circuit board bonding portion, the second sub-circuit board bonding portion, the third sub-circuit board bonding portion, and the fourth sub-circuit board bonding portion are disposed on the same surface of the flexible substrate 201. The surface of the flexible substrate 201 are provided with a plurality of through holes, and a conductive material is filled into the through holes to form electrical connecting points 213. The electrode lead line on the other surface of the flexible substrate 201 can be connected to the corresponding circuit board bonding portion through the electrical connecting points 213.

Compared with the first preferred embodiment, because all of the circuit board bonding portions are disposed on the same surface, all of the circuit board bonding portions can be manufactured at one time during manufacturing process. Compared with manufacturing on two surfaces, it can save one turning process, and prevent the circuits from being damaged by the turning process.

The present invention further provides a flexible touch display, and the flexible touch display of the preferably embodiment comprises the above-mentioned flexible touchscreen in FIGS. 1 and 2, which are not described again here.

The advantageous effects of the present invention are: compared with a conventional flexible touchscreen, in the flexible touchscreen of the present invention, because electrodes and electrode lead lines are arranged to avoid a bending area of the touchscreen, the electrodes are prevented from being bent, so as to decrease a damage of the electrode lead lines caused by a bending stress of the touchscreen, so that the service life of the flexible touchscreen is increased. The present invention can solve a technical problem: in a conventional flexible touchscreen, the electrode circuits thereof in a bended portion are easily worn or broken by an accumulation of stress, so as to influence the touch effect of the flexible touchscreen.

The present invention has been described with preferred embodiments thereof and it is understood that many changes and modifications to the described embodiment can be carried out without departing from the scope and the spirit of the invention that is intended to be limited only by the appended claims.

What is claimed is:

1. A flexible touchscreen, comprising:
a flexible substrate, each surface of which is defined as a bending area and two window areas, wherein a plurality of electrode layers are manufactured on the surfaces of the flexible substrate; a midline area of each of the electrode layers is empty; the midline area is formed as the bending area; the electrode layers beside the midline area are formed as the two window areas; and the two window areas are symmetrically disposed according to an axis formed by a midline of the bending area;
a first circuit board bonding unit disposed on one side of the bending area;
a second circuit board bonding unit disposed on the other side of the bending area;
a first electrode lead line group disposed on the same side of the first circuit board bonding unit as the bending area, wherein the first electrode lead line group is configured to connect the electrode layer of the same side and the first circuit board bonding unit; and
a second electrode lead line group disposed on the same side of the second circuit board bonding unit as the bending area, wherein the second electrode lead line group is configured to connect the electrode layer of the same side and the second circuit board bonding unit.

2. The flexible touchscreen according to claim 1, wherein the electrode layers include driving electrodes and sensing electrodes insulated from each other; the driving electrodes are manufactured on one surface of the flexible substrate; and the sensing electrodes are manufactured on the other surface of the flexible substrate.

3. The flexible touchscreen according to claim 2, wherein the first circuit board bonding unit includes a first sub-circuit board bonding portion and a second sub-circuit board bonding portion; and the second circuit board bonding unit includes a third sub-circuit board bonding portion and a fourth sub-circuit board bonding portion; and
the first electrode lead line group includes a first sub-electrode lead line and a second sub-electrode lead line; and the second electrode lead line group includes a third sub-electrode lead line and a fourth sub-electrode lead line; wherein the first sub-electrode lead line is configured to connect between the sensing electrodes and the second sub-circuit board bonding portion; the second sub-electrode lead line is configured to connect between the driving electrodes and the first sub-circuit board bonding portion; the third sub-electrode lead line is configured to connect between the sensing electrodes and the fourth sub-circuit board bonding portion; and the fourth sub-electrode lead line is configured to connect between the driving electrodes and the third sub-circuit board bonding portion.

4. The flexible touchscreen according to claim 3, wherein the first sub-electrode lead line, the third sub-electrode lead line, the second sub-circuit board bonding portion, the fourth sub-circuit board bonding portion, and the sensing electrodes are positioned on the same surface of the flexible substrate; and the second sub-electrode lead line, the fourth sub-electrode lead line, the first sub-circuit board bonding portion, the third sub-circuit board bonding portion, and the driving electrodes are positioned on the other surface of the flexible substrate.

5. The flexible touchscreen according to claim 3, wherein the first sub-circuit board bonding portion, the second sub-circuit board bonding portion, the third sub-circuit board bonding portion, and the fourth sub-circuit board bonding portion are positioned on the same surface of the flexible substrate; and the surfaces of the flexible substrate are provided with a plurality of through holes, and electrical connecting points are filled in the through holes, so that the electrode lead line on the other surface of the flexible substrate is connected to the corresponding circuit board bonding portion through the electrical connecting points.

6. A flexible touchscreen, comprising:
a flexible substrate, each surface of which is defined as a bending area and two window areas, wherein a plurality of electrode layers are manufactured on the surfaces of the flexible substrate; a midline area of each of the electrode layers is empty; the midline area is formed as the bending area; and the electrode layers beside the midline area are formed as the two window areas;
a first circuit board bonding unit disposed on one side of the bending area;
a second circuit board bonding unit disposed on the other side of the bending area;
a first electrode lead line group disposed on the same side of the first circuit board bonding unit as the bending area, wherein the first electrode lead line group is configured to connect the electrode layer of the same side and the first circuit board bonding unit; and
a second electrode lead line group disposed on the same side of the second circuit board bonding unit as the bending area, wherein the second electrode lead line group is configured to connect the electrode layer of the same side and the second circuit board bonding unit.

7. The flexible touchscreen according to claim 6, wherein the electrode layers include driving electrodes and sensing electrodes insulated from each other; the driving electrodes are manufactured on one surface of the flexible substrate; and the sensing electrodes are manufactured on the other surface of the flexible substrate.

8. The flexible touchscreen according to claim 7, wherein the first circuit board bonding unit includes a first sub-circuit board bonding portion and a second sub-circuit board bonding portion; and the second circuit board bonding unit includes a third sub-circuit board bonding portion and a fourth sub-circuit board bonding portion; and
the first electrode lead line group includes a first sub-electrode lead line and a second sub-electrode lead line; and the second electrode lead line group includes a third sub-electrode lead line and a fourth sub-electrode lead line; wherein the first sub-electrode lead line is configured to connect between the sensing electrodes and the second sub-circuit board bonding portion; the second sub-electrode lead line is configured to connect between the driving electrodes and the first sub-circuit board bonding portion; the third sub-electrode lead line is configured to connect between the sensing electrodes and the fourth sub-circuit board bonding portion; and the fourth sub-electrode lead line is configured to connect between the driving electrodes and the third sub-circuit board bonding portion.

9. The flexible touchscreen according to claim 8, wherein the first sub-electrode lead line, the third sub-electrode lead line, the second sub-circuit board bonding portion, the fourth sub-circuit board bonding portion, and the sensing electrodes are positioned on the same surface of the flexible substrate; and the second sub-electrode lead line, the fourth sub-electrode lead line, the first sub-circuit board bonding portion, the third sub-circuit board bonding portion, and the driving electrodes are positioned on the other surface of the flexible substrate.

10. The flexible touchscreen according to claim 8, wherein the first sub-circuit board bonding portion, the second sub-circuit board bonding portion, the third sub-circuit board bonding portion, and the fourth sub-circuit board bonding portion are positioned on the same surface of the flexible substrate; and the surfaces of the flexible substrate are provided with a plurality of through holes, and electrical connecting points are filled in the through holes, so that the electrode lead line on the other surface of the flexible substrate is connected to the corresponding circuit board bonding portion through the electrical connecting points.

11. A flexible touch display, comprising:
a flexible display; and
a flexible touchscreen positioned on an upper surface of the flexible display and electrically connected with the flexible display;
wherein the flexible touchscreen comprises:
a flexible substrate, each surface of which is defined as a bending area and two window areas, wherein a plurality of electrode layers are manufactured on the surfaces of the flexible substrate; a midline area of each of the electrode layers is empty; the midline area is formed as the bending area; the electrode layers beside the midline area are formed as the two window areas; and the two window areas are symmetrically disposed according to an axis formed by a midline of the bending area;
a first circuit board bonding unit disposed on one side of the bending area;
a second circuit board bonding unit disposed on the other side of the bending area;
a first electrode lead line group disposed with the same side of the first circuit board bonding unit as the bending area, wherein the first electrode lead line group is configured to connect the electrode layer of the same side and the first circuit board bonding unit; and
a second electrode lead line group disposed with the same side of the second circuit board bonding unit as the bending area, wherein the second electrode lead line group is configured to connect the electrode layer of the same side and the second circuit board bonding unit.

12. The flexible touch display according to claim 11, wherein the electrode layers include driving electrodes and sensing electrodes insulated from each other; the driving electrodes are manufactured on one surface of the flexible substrate; and the sensing electrodes are manufactured on the other surface of the flexible substrate.

13. The flexible touch display according to claim 12, wherein the first circuit board bonding unit includes a first sub-circuit board bonding portion and a second sub-circuit board bonding portion; and the second circuit board bonding unit includes a third sub-circuit board bonding portion and a fourth sub-circuit board bonding portion; and
the first electrode lead line group includes a first sub-electrode lead line and a second sub-electrode lead line; and the second electrode lead line group includes a third sub-electrode lead line and a fourth sub-electrode lead line; wherein the first sub-electrode lead line is configured to connect between the sensing electrodes and the second sub-circuit board bonding portion; the second sub-electrode lead line is configured to connect between the driving electrodes and the first sub-circuit board bonding portion; the third sub-electrode lead line is configured to connect between the sensing electrodes and the fourth sub-circuit board bonding portion; and the fourth sub-electrode lead line is configured to connect between the driving electrodes and the third sub-circuit board bonding portion.

14. The flexible touch display according to claim 13, wherein the first sub-electrode lead line, the third sub-electrode lead line, the second sub-circuit board bonding portion, the fourth sub-circuit board bonding portion, and the sensing electrodes are positioned on the same surface of the flexible substrate; and the second sub-electrode lead line, the fourth sub-electrode lead line, the first sub-circuit board bonding portion, the third sub-circuit board bonding portion, and the driving electrodes are positioned on the other surface of the flexible substrate.

15. The flexible touch display according to claim 13, wherein the first sub-circuit board bonding portion, the second sub-circuit board bonding portion, the third sub-circuit board bonding portion, and the fourth sub-circuit board bonding portion are positioned on the same surface of the flexible substrate; and the surfaces of the flexible substrate are provided with a plurality of through holes, and electrical connecting points are filled in the through holes, so that the electrode lead line on the other surface of the flexible substrate is connected to the corresponding circuit board bonding portion through the electrical connecting points.
